(19) United States
(12) Patent Application Publication
(10) Pub. No.: US 2005/0000104 A1
(43) Pub. Date: Jan. 6, 2005

(54) Acetabular measuring device

(76) Inventor: Uri Arnin, Kiryar Tivon (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 10/880,564

(22) Filed: Jul. 1, 2004

Related U.S. Application Data
(60) Provisional application No. 60/483,902, filed on Jul. 2, 2003.

(51) Int. Cl. G01B 3/22

(52) U.S. Cl. 33/555.1

(57) ABSTRACT

A concave radius gauge including a contact probe arranged for moving in and out of a cavity formed in a gauge body, the contact probe having a probe contact point and the gauge body having two gauge contact points for contacting a concave surface that has a radius of curvature, and a distance sensor adapted to sense a distance that the contact probe protrudes beyond the gauge body while at a contact position, the contact position being defined by the probe contact point and the two gauge contact points all contacting the concave surface, wherein the radius of curvature of the concave surface is calculable as a function of the distance.

### CROSS-REFERENCE TO RELATED APPLICATIONS

This application claims priority under 35 USC §119 to U.S. Provisional Patent Application Ser. No. 60/483,902, filed on Jul. 2, 2003, which is incorporated herein by reference.

### FIELD OF THE INVENTION

The present invention relates to a concave radius gauge, and particularly to a measuring device useful in determining a size of an acetabulum in conjunction with orthopedic arthoplasty of an articulating joint.

### BACKGROUND OF THE INVENTION

Articulating joints may become injured or diseased and require repair, such as replacement of a portion of the joint with an artificial implant. Articulating joints include ball-and-socket joints, such as the hip joint and the shoulder joint.

The hip joint is called a ball-and-socket joint because the spherical head of the thighbone (femur) moves inside a cup-shaped socket (acetabulum) of the pelvis. In order to alleviate problems associated with a diseased or injured hip joint, at least some of the parts of the hip may be replaced in a hip replacement operation.

A more drastic operation called a Total Hip Replacement (THR) may be required when there is extensive damage to both the femoral and acetabular components. In the THR procedure a total hip replacement implant may have three main parts: the stem, which fits into the femur and provides stability; the ball, which replaces the spherical femoral head; and the cup, which replaces the worn-out acetabulum.

However, in cases where disease or injury is limited to the femoral bone, such as a displaced fracture of the femoral neck, which commonly occurs in elderly patients, it may be sufficient to replace the femoral head alone in what is called a Partial Hip Replacement (PHR) or hemi-arthroplasty. The PHR involves removal of the femoral head and neck and implantation of a stemmed prosthesis in the femur. The prosthetic femoral head comes in various sizes in accordance with the individual's dimensions. Accurate sizing of the femoral head prosthesis is crucial to the success of the procedure. Too tight of a fit between the artificial femoral surface and the native acetabulum or too much clearance results in a small contact area, resulting in significant wear between the femoral head prosthesis and the natural acetabular cup.

Current medical practice typically requires that, after the natural femoral head has been removed, the surgeon measures the diseased or fractured head and replaces it with an artificial one based on these measurements. There are distinct and inherent disadvantages to this method. For example, the femoral head may be diseased and have lost its original shape making it very difficult to arrive at the correct size.

Alternate medical practice requires measurement of the acetabular cup that is to receive the prosthetic femoral head employing various types of calipers. Although this approach of measuring the cup theoretically provides the surgeon with a precise size for the desired femoral prosthesis, the measurement is inherently inaccurate because of the inadequate and limited configurations of currently available measuring calipers.

European Patent Application EP0860143, assigned to Howmedica International Inc., describes devices for measuring a diametric profile of an acetabulum and marking information concerning the profile on a prosthesis to be implanted. Measurement is achieved by a body portion with a number of adjustable peripherally projecting indicators. The application describes a special configuration of calipers and shares the disadvantages of other caliper based measurement systems.

British Patent Application GB02371868, assigned to Precimed S.A., describes a device for measurement of the depth of a hole dilled in bone to which direct linear access is not available. However, nothing is taught about measuring the acetabulum.

### SUMMARY OF THE INVENTION

The present invention is directed to a concave radius gauge, which can be used as an acetabular measuring device to determine the radius of curvature of the acetabulum, as is described more in detail hereinbelow.

There is thus provided in accordance with an embodiment of the present invention a concave radius gauge including a contact probe arranged for moving in and out of a cavity formed in a gauge body, the contact probe having a probe contact point and the gauge body having two gauge contact points for contacting a concave surface that has a radius of curvature, and a distance sensor adapted to sense a distance that the contact probe protrudes beyond the gauge body while at a contact position, the contact position being defined by the probe contact point and the two gauge contact points all contacting the concave surface, wherein the radius of curvature of the concave surface is calculable as a function of the distance.

The concave radius gauge can include one or more of the following features. For example, a biasing device may be disposed in the gauge body, adapted to apply an urging force on the contact probe. A stop may be disposed in the gauge body, adapted to limit movement of the contact probe. A processor may be provided, which can process the sensed distance and determine the radius of curvature of the concave surface. A display may be in communication with the processor for displaying the radius of curvature of the concave surface. A contact sensor may be mounted in the contact probe adapted to sense when the probe contact point contacts the concave surface. Similarly, a contact sensor may be mounted in the gauge body adapted to sense when the gauge contact points contact the concave surface.

### BRIEF DESCRIPTION OF THE DRAWINGS

In the drawings:

FIG. 1 is a simplified, partially sectional illustration of a concave radius gauge, constructed and operative in accordance with an embodiment of the present invention; and

FIG. 2 is a simplified, partially sectional illustration of the concave radius gauge of FIG. 1 when pressed against a concave surface, such as the acetabulum.

### DESCRIPTION OF EMBODIMENTS

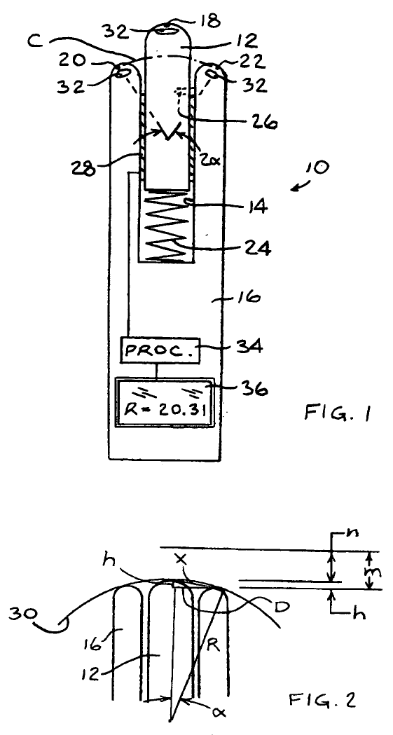

Reference is now made to FIG. 1, which illustrates a concave radius gauge 10, constructed and operative in accordance with an embodiment of the present invention.

Concave radius gauge 10 may include a contact probe 12 arranged for moving in and out of a cavity 14 formed in a distal portion of a gauge body 16. Contact probe 12 may have a probe contact point 18. Gauge body 16 may have two gauge contact points 20 and 22 on a distal shoulder portion of the gauge body 16. The probe contact point 18 and the gauge contact points 20 and 22 may contact a concave surface that has a radius of curvature, as described further hereinbelow.

A biasing device 24 may be disposed in gauge body 16, adapted to apply an urging force on contact probe 12, such as to urge contact probe 12 out of cavity 14 (or alternatively into the cavity 14). For purposes of this specification and the accompanying claims, the term “biasing device” includes, without limitation, one or more springs, one or more elastic bands, teeth, gears, ratchets and combinations thereof.

A stop 26 may be provided in gauge body 16, which limits the movement of contact probe 12 (inward or outward, depending whether the biasing device 24 urges the contact probe 12 outwards or inwards). For example, stop 26 may include, without limitation, a pin that engages a notch formed on contact probe 12.

A distance sensor 28 may be mounted in gauge body 16. Distance sensor 28 may sense a distance traveled by contact probe 12 as it slides in cavity 14. Distance sensor 28 may include, without limitation, a linear encoder. As another example, distance sensor 28 may simply be graduation marks formed on the contact probe 12, and the biasing device 24 may be such that when contact probe 12 moves into cavity 14, the biasing device 24 retains the contact probe 12 in the retracted position (ratchets are examples of such a biasing device). In such an embodiment, the distance is simply read from the graduation marks.

Reference is now made to FIG. 2, which illustrates concave radius gauge 10 when pressed against a concave surface 30, such as the acetabulum. The contact position is defined by the probe contact point 18 and the two gauge contact points 20 and 22 all contacting the concave surface 30.

The distance from the tip of contact probe 12 (from the initial position shown in FIG. 1) to the tip of gauge body 16 is indicated by the letter m. As mentioned before, distance sensor 28 may sense the distance n traveled by contact probe 12 as it slides in cavity 14 to the contact position (that shown in FIG. 2). The distance that contact probe 12 protrudes beyond gauge body 16 while at the contact position is designated h (h=m−n).

One non-limiting example of calculating the radius of curvature R as a function of the distance h is now explained.

First, the positions of the two gauge contact points 20 and 22 are assumed known, such as at the outer distal shoulders of gauge body 16. This is a simplifying, but strictly speaking inaccurate, assumption. The inaccuracy may be negligent, but for even better accuracy, one or more contact sensors 32 may be mounted in contact probe 12 and gauge body 16 that sense when and where the probe contact point 18 or gauge contact points 20 and 22 contact the concave surface 30. The contact sensors 32 may include, without limitation, proximity sensors or capacitance sensors.

The geometry of the concave radius gauge 10 is known, and defines two geometrical properties. First, the two gauge contact points 20 and 22 lie along an imaginary circle C and subtend an angle 2α. Second, the distance D is defined as the distance from the longitudinal axis that intersects the probe contact point 18 to the longitudinal axis that intersects one of the two gauge contact points 20 and 22.

When the probe contact point 18 and the two gauge contact points 20 and 22 all contact the concave surface 30, α is the angle subtended from the probe contact point 18 to one of the two gauge contact points 20 and 22. Making a small angle assumption, α is approximately equal to the hypotenuse x of the triangle formed by sides h and D. Thus, x/R=α. Since 2α is already known, R is readily determined.

It is emphasized that this is just one way of calculating R, and the invention is not at all limited to this example.

The concave radius gauge 10 may include a processor 34, which may be in communication with distance sensor 28, adapted to process the sensed distance h and determine the radius of curvature R, as explained above. A display 36 may be in communication with the processor 34 for displaying the radius of curvature R. For purposes of this specification and the accompanying claims, “display” refers to any device for presentation of data to a user, such as but not limited to, speakers, earphones, LCD screens, LED displays, CRT displays and active matrix displays.

Once the radius of curvature R has been derived, a surgeon can choose a replacement femoral head that will be a very precise fit for the patient's acetabular cup, thus reducing any complications that may arise due to a badly matched ball and socket, as mentioned above.

It will be appreciated that the above descriptions are intended only to serve as examples and that many other embodiments are possible within the spirit and the scope of the present invention. Although various specific implementations have been described, it is evident that many alternatives, modifications and variations will be apparent to those skilled in the art. Accordingly, other alternatives, modifications, and variations fall within the scope of the following claims.

1. A concave radius gauge comprising:
a contact probe arranged for moving in and out of a cavity formed in a gauge body, said contact probe having a probe contact point and said gauge body having two gauge contact points for contacting a concave surface that has a radius of curvature; and
a distance sensor adapted to sense a distance that said contact probe protrudes beyond said gauge body while at a contact position, the contact position being defined by the probe contact point and the two gauge contact points all contacting the concave surface, wherein the radius of curvature of the concave surface is calculable as a function of said distance.

2. The concave radius gauge according to claim 1, further comprising a biasing device disposed in said gauge body, adapted to apply an urging force on said contact probe.

3. The concave radius gauge according to claim 2, further comprising a stop disposed in said gauge body, adapted to limit movement of said contact probe.

4. The concave radius gauge according to claim 1, further comprising a processor adapted to process the sensed distance and determine the radius of curvature of the concave surface.

5. The concave radius gauge according to claim 4, further comprising a display in communication with the processor for displaying the radius of curvature of the concave surface.

6. The concave radius gauge according to claim 1, further comprising a contact sensor mounted in said contact probe adapted to sense when said probe contact point contacts the concave surface.

7. The concave radius gauge according to claim 1, further comprising a contact sensor mounted in said gauge body adapted to sense when said gauge contact points contact the concave surface.
